(19) United States
(12) Patent Application Publication
(10) Pub. No.: US 2015/0272278 A1
(43) Pub. Date: Oct. 1, 2015

(54) ADHESION FOR SHOE SOLE BONDING

(71) Applicant: Nanotech Ceramics Co., Ltd., Busan City (KR)

(72) Inventor: Sang-Ok Jeong, Busan-si (KR)

(73) Assignee: Nanotech Ceramics Co., Ltd., Busan City (KR)

(21) Appl. No.: 14/229,009

(22) Filed: Mar. 28, 2014

(51) Int. Cl. A43D 25/06; C09J 175/02; A43B 13/02

(52) U.S. Cl. CPC A43D 25/06; A43B 13/026; C09J 175/02

(57) ABSTRACT

Embodiments of the present invention provide a method for constructing a shoe sole. Specifically, among other things, embodiments of the present invention provide a method for constructing a shoe sole including adhering an outsole to a midsole. The outsole is formed from an outsole compound. The outsole compound may include an organic compound and a porous material. The organic compound may have a boiling point greater than 120° C. The porous material may have a specific surface area greater than two square meters per gram. The organic compound may be supported on the porous material. The outsole is adhered to the midsole using an adhesive that includes an amine group composition.

### TECHNICAL FIELD

In general, the present invention relates to an adhesive bonding process and, more particularly, to adhesive bonding of a shoe sole that reduces the bonding process by including a reactive amine group compound in the adhesive.

### BACKGROUND

A shoe is an item of footwear intended to protect and comfort the human foot while doing various activities. Shoes are also used as an item of decoration. The design of shoes has varied enormously through time and from culture to culture, with appearance originally being tied to function. Additionally, fashion has often dictated many design elements, such as whether shoes have very high heels or flat ones. Contemporary footwear varies widely in style, complexity, and cost. Basic sandals may consist of only a thin sole and simple strap. High fashion shoes may be made of very expensive materials in complex construction and sell for thousands of dollars a pair. Other shoes are for very specific purposes, such as boots specially designed for mountaineering or skiing.

Known shoe soles generally have a three layered structure. They consist of an outsole, a midsole, and an inner sole. The outsole provides the shoe with an outer profile so that it meets the requirement of a good grip with the respective ground. Furthermore, the outsole is typically made of a non-abrasive material to assure high wear resistance and a long lifetime of the sole. The midsole is often made of a foamed plastic (e.g., elastomers) with different densities. Based on the ability of the midsole material to deform reversibly, it absorbs or dampens mechanical impacts which are generated during the walking and running motions and which are transmitted to the body of the shoe wearer via the shoe. The damping of the mechanical impacts induced in this way can be supported by the integration of damping elements of different construction. Additionally, the midsole often serves for receiving stability or support elements which are made of lightweight and stable plastics and which support the foot during walking and running. Based on their selectively adjustable flexibility, a further function of this stability or support element is the support of the walking and running motions of the shoe wearer.

The connection of the above-referenced parts of a sole, specifically the outsole and midsole, can be realized with different methods known from the prior art. In this context, conventional methods comprise stitching, sewing, and cementing. In construction of shoe soles, the two layers are conventionally connected by means of adhesive which has several disadvantages. Based on their constitution, presently used adhesives are often volatile and harmful to the environment because of the emission of certain dusts, gases, and industrial wastes. Additionally, the known adhesives do not form a favorable bond (e.g., between rubber and plastic sole elements), therefore no durable connection is achieved and the shoe elements become detached from one another. It is therefore the problem of the present invention to provide a method for providing an adhesive to be used in the bonding process which is less expensive and less time consuming than conventional prior art methods.

### SUMMARY

In general, embodiments of the present invention provide a method for constructing a shoe sole. Specifically, among other things, embodiments of the present invention provide a method for constructing a shoe sole including adhering an outsole to a midsole. The outsole is formed from an outsole compound. The outsole compound may include an organic compound and a porous material. The organic compound may have a boiling point greater than 120° C. The porous material may have a specific surface area greater than two square meters per gram. The organic compound may be supported on the porous material. The outsole is adhered to the midsole using an adhesive that includes an amine group composition.

A first aspect of the present invention provides a method for constructing a shoe sole, comprising: providing a midsole; providing an outsole compound; forming an outsole from the outsole compound; and adhering the outsole to the midsole using an adhesive compound, wherein the adhesive compound includes an amine group composition.

A second aspect of the present invention provides a shoe sole structure, comprising: a midsole; and an outsole formed from an outsole compound, wherein the outsole is adhered to the midsole using an adhesive compound, wherein the adhesive compound includes an amine group composition.

A third aspect of the present invention provides a method for providing a shoe structure, comprising: providing an outsole compound, wherein the outsole compound includes an organic compound and a porous material, and wherein the organic compound is supported on the porous material; forming an outsole from the outsole compound; and adhering the outsole to the midsole using an adhesive compound, wherein the adhesive compound includes an amine group composition.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a lateral side view of a shoe according to an embodiment of the present invention;

FIG. 2 depicts a general bonding process for bonding an outsole and a midsole according to an embodiment of the present invention;

FIG. 3 depicts a general bonding process for bonding an outsole and an upper according to an embodiment of the present invention;

FIG. 4 depicts an example chemical formula according to an embodiment of the present invention; and

FIG. 5 depicts a table of amine compounds that may be used in the adhesive formula according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide a method for constructing a shoe sole. Specifically, among other things, embodiments of the present invention provide a method for constructing a shoe sole including adhering an outsole to a midsole. The outsole is formed from an outsole compound. The outsole compound may include an organic compound and a porous material. The organic compound may have a boiling point greater than 120° C. The porous material may have a specific surface area greater than two square meters per gram. The organic compound may be supported on the porous material. The outsole is adhered to the midsole using an adhesive that includes an amine group composition.

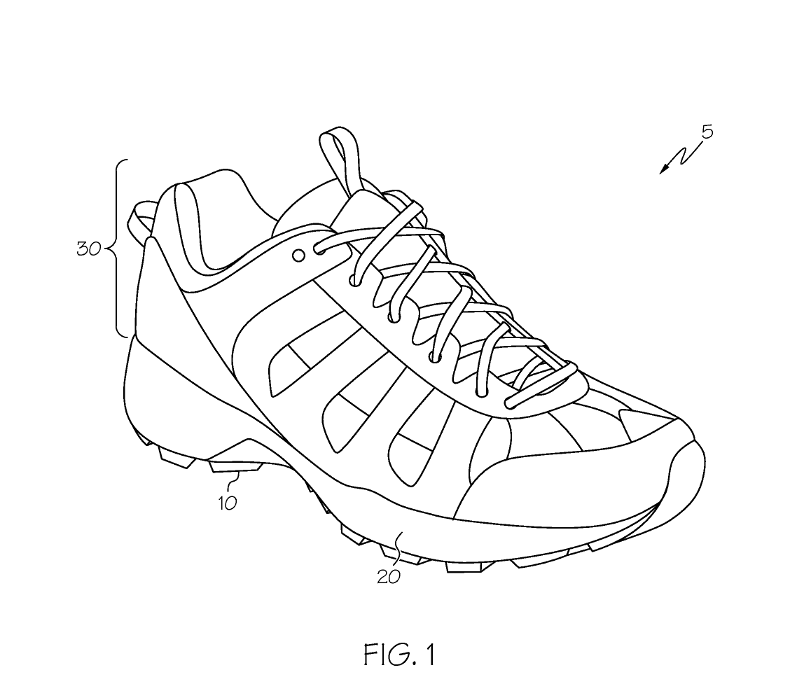

FIG. 1 depicts a lateral side view of a shoe 5 according to one embodiment of the present invention. As shown, the shoe 5 includes outsole 10, midsole 20, and upper 30. The outsole 10 is a treaded layer secured to the bottom of the midsole 20. The outsole 10 is produced to resist wear, provide traction, and absorb shock. The midsole 20 is located between the outsole 10 and the upper 30. With running shoes, the midsole is generally considered the most important part of the shoe. It is intended to control excessive foot motion and provide cushioning and shock absorption. Many shoes are also cushioned with gel, foam, or various manufacturer-specific technologies that are encapsulated in the midsole 20. The outsole 10, midsole 20, and upper 30 are secured together to form the base of the shoe 5. The manufacturing methods of midsole 20 and outsole 10 are well known in the art and are not described in detail.

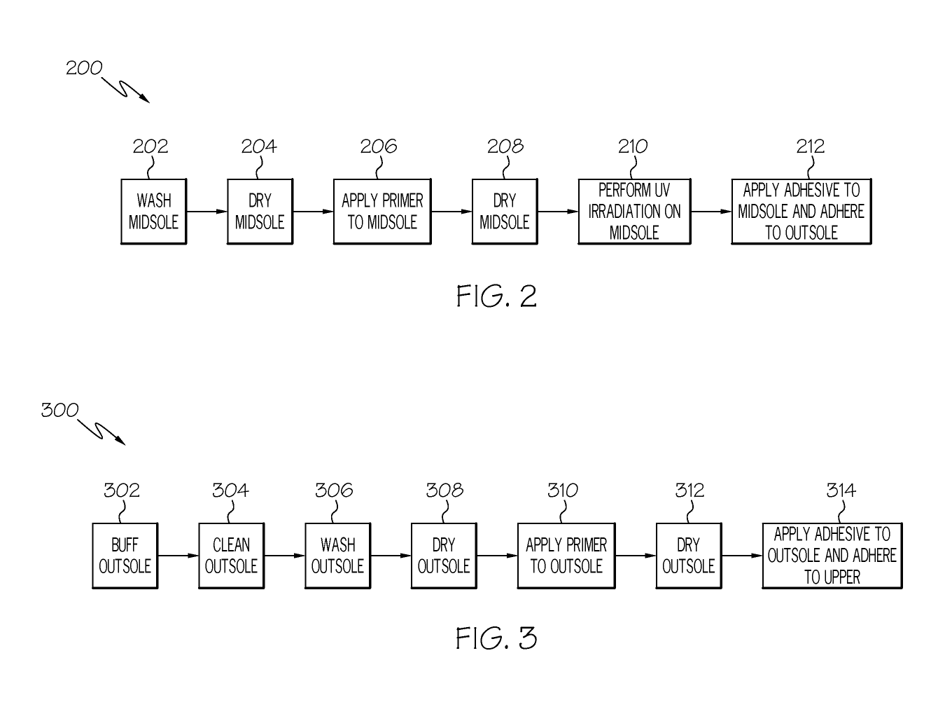

FIG. 2 depicts a general bonding process 200 for bonding the outsole 10 and midsole 20. Conventionally, the outsole 10 is bonded to the midsole 20 through a bonding process as described in detail below. At 202, the midsole 20 may be washed with warm water. At 204, the midsole 204 may be dried in an oven at approximately 60° Celsius (C). At 206, a primer may be applied to the midsole 20. The primer may be solvent-based or water-based. After the primer is applied, the midsole 20 is again dried in an oven at approximately 60° C. for approximately five minutes. At 210, the midsole 20 may be sterilized through ultraviolet (UV) irradiation. Ultraviolet irradiation is the sterilization of an object through the use of a particular wavelength of ultraviolet light. UV irradiation may be performed two times. At step 212, the adhesive is applied to the outsole 10 and the outsole 10 is adhered to the midsole 20.

FIG. 3 depicts a general bonding process 300 for bonding the outsole 10 to the upper 30. Conventionally, the outsole 10 is bonded to the upper 30 through a bonding process as described in detail below. At 302, the outsole 10 may be buffed. At 304, the outsole 10 may be cleaned. At 306, the outsole 10 may be washed. Next, the outsole 10 may be dried at 308. At 310, a primer may be applied to the outsole 10. At 312, the outsole 10 may be dried again. Finally, at 314, an adhesive is applied to the outsole 10 and the outsole 10 is adhered to the upper 30.

As shown, the adhesive process includes buffing or cleaning, applying a primer, and then applying an adhesive. Improving the adhesive process may reduce shoe manufacturing time and costs, as well as improve the stabilization of the shoe. By placing a pre-committed substance into the adhesive formulation, the adhesion process may be significantly reduced. Current processes put an OH group into the adhesive formulation to improve the adhesion. This produces a urethane reaction. The present invention puts a reactive amine group compound into the formulation for the adhesive to reduce the bonding process. This produces a urea reaction. Amines are organic compounds and functional groups that contain a basic nitrogen atom with a lone pair. Amines are derivatives of ammonia, wherein one or more hydrogen atoms have been replaced by a substituent such as an alkyl or aryl group.

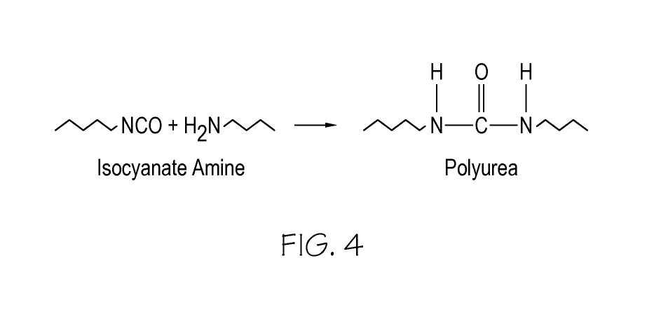

FIG. 4 depicts a chemical formula that indicates a urea reaction between a molecule of the isocyanate amine group and a molecule of the polyurea group. The isocyanate amine group is a more reactive group than the alcohol group. Therefore, the adhesive compound may be used in the isocyanate amine group as an alternative to the alcohol group to produce a better adhesive. The amine group may be present in the amount of approximately 3 to 150 parts per hundred by weight of the adhesive compound.

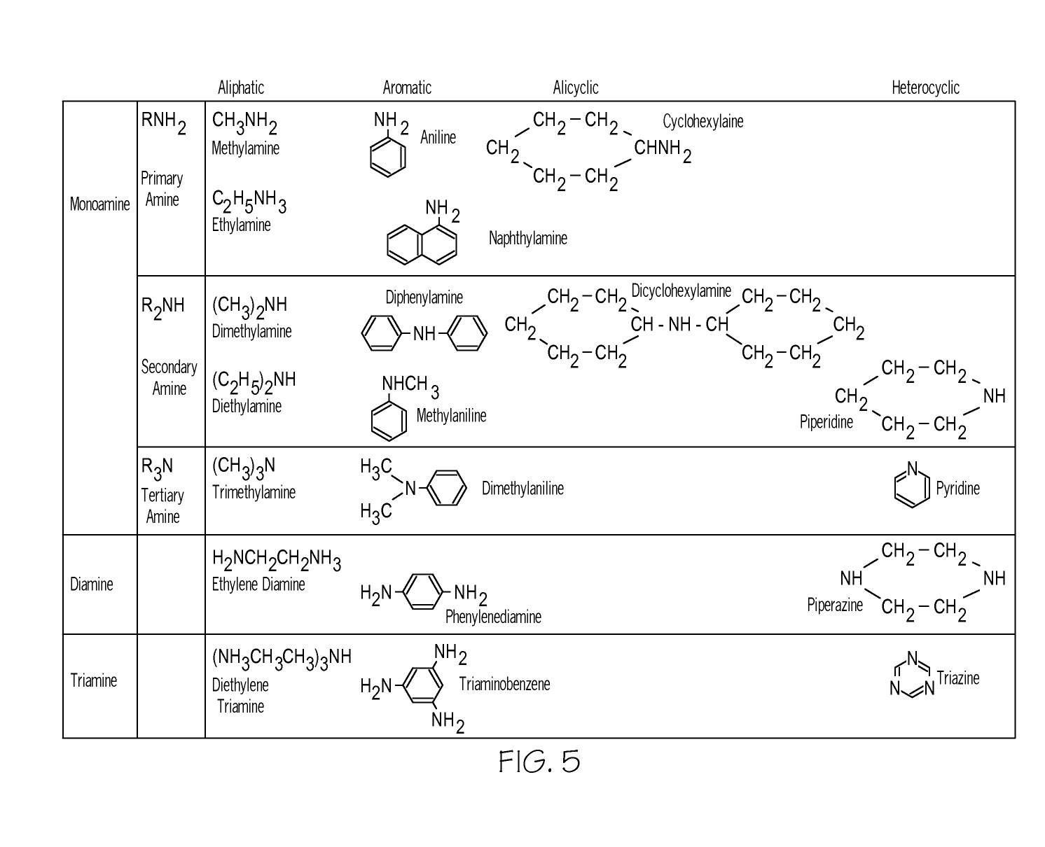

FIG. 5 depicts a table of amine compositions that may be used in the adhesive formula. Amines are organized into four subcategories: primary amines, secondary amines, tertiary amines, and cyclic amines. Primary amines arise when one of three hydrogen atoms in ammonia is replaced by an alkyl or aromatic. Important primary alkyl amines include methylamine, ethanolamine (2-aminoethanol), and the buffering agent tris, while primary aromatic amines include aniline. Secondary amines have two organic substituents (alkyl, aryl or both) bound to N together with one hydrogen (or no hydrogen if one of the substituent bonds is double). Important representatives include dimethylamine and methylethanolamine, while an example of an aromatic amine would be diphenylamine. In tertiary amines, all three hydrogen atoms are replaced by organic substituents. Examples include trimethylamine, which has a distinctively fishy smell or triphenylamine. Cyclic amines are either secondary or tertiary amines. Examples of cyclic amines include the 3-member ring aziridine and the six-membered ring piperidine. N-methylpiperidine and N-phenylpiperidine are examples of cyclic tertiary amines.

Amines are named in several ways. Typically, the compound is given the prefix “amino-” or the suffix: “-amine”. The prefix “N-” shows substitution on the nitrogen atom. An organic compound with multiple amino groups is called a diamine, triamine, tetraamine, and so forth. As shown, the amine group composition may include at least one of the following: methylamine, ethylamine, aniline, naphthylamine, dimethylamine, diethylamine, diphenyl amine, methylaniline, piperidine, triethlamine, dimethylaniline, pyridine, ethylendiamine, phenylenediamine, diethylenetriamine, triamonobenzene, or triamine. The adhesive compound may also include a liquid amine composition. The liquid amine composition may be sunk by a sink catalyst such as silica, magnesium carbonate, diatomaceous earth, or zeolite. In one example, the amine group is present in the amount of approximately 3 to 150 parts per hundred by weight of the adhesive compound.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for constructing a shoe sole, comprising:
providing a midsole;
providing an outsole compound;
forming an outsole from the outsole compound; and
adhering the outsole to the midsole using an adhesive compound, wherein the adhesive compound includes an amine group composition.

2. The method of claim 1, wherein the amine group composition includes at least one of methylamine, ethylamine, aniline, naphthylamine, dimethylamine, diethylamine, diphenyl amine, methylaniline, piperidine, triethlamine, dimethylaniline, pyridine, ethylendiamine, phenylenediamine, diethylenetriamine, triamonobenzene, or triamine.

3. The method of claim 1, wherein the amine group composition is a liquid amine composition.

4. The method of claim 1, wherein the amine group composition is present in the amount of approximately 3 to 150 parts per hundred by weight of the adhesive compound.

5. The method of claim 1, wherein the outsole includes a polymer composition.

6. The method of claim 1, further comprising providing an upper and adhering the outsole to the upper using the adhesive compound.

7. A shoe sole structure, comprising:
a midsole; and
an outsole formed from an outsole compound, wherein the outsole is adhered to the midsole using an adhesive compound, wherein the adhesive compound includes an amine group composition.

8. The shoe sole structure of claim 7, wherein the amine group composition includes at least one of methylamine, ethylamine, aniline, naphthylamine, dimethylamine, diethylamine, diphenyl amine, methylaniline, piperidine, triethlamine, dimethylaniline, pyridine, ethylendiamine, phenylenediamine, diethylenetriamine, triamonobenzene, or triamine.

9. The shoe sole structure of claim 7, wherein the amine group composition is a liquid amine composition.

10. The shoe sole structure of claim 7, wherein the amine group composition is present in the amount of approximately 3 to 150 parts per hundred by weight of the adhesive compound.

11. The shoe structure of claim 7, wherein the outsole compound includes a polymer composition.

12. The shoe structure of claim 7, further comprising an upper, wherein the upper is adhered to the outsole using the adhesive compound.

13. A method for providing a shoe structure, comprising:
providing an outsole compound, wherein the outsole compound includes an organic compound and a porous material, and wherein the organic compound is supported on the porous material;
forming an outsole from the outsole compound; and
adhering the outsole to the midsole using an adhesive compound, wherein the adhesive compound includes an amine group composition.

14. The method of claim 13, wherein the outsole compound includes a polymer composition.

15. The method of claim 13, wherein the amine group composition includes at least one of methylamine, ethylamine, aniline, naphthylamine, dimethylamine, diethylamine, diphenyl amine, methylaniline, piperidine, triethlamine, dimethylaniline, pyridine, ethylendiamine, phenylenediamine, diethylenetriamine, triamonobenzene, or triamine.

16. The method of claim 13, wherein the amine group composition is a liquid amine composition.

17. The method of claim 13, wherein the amine group composition is present in the amount of approximately 3 to 150 parts per hundred by weight of the adhesive compound.

18. The method of claim 13, further comprising providing an upper and adhering the outsole to the upper using the adhesive compound.
